(19) United States
(12) Patent Application Publication
(10) Pub. No.: US 2015/0059977 A1
(43) Pub. Date: Mar. 5, 2015

(54) SUPPORT FIXTURE AND CAP FOR THE ACID ETCHING OF PCD CUTTING INSERTS

(71) Applicant: Stingray Group, LLC, Layton, UT (US)

(72) Inventor: Allen Turner, Layton, UT (US)

(73) Assignee: Stingray Group, LLC, Layton, UT (US)

(21) Appl. No.: 14/019,226

(22) Filed: Sep. 5, 2013

(51) Int. Cl. C04B 41/53

(52) U.S. Cl. CPC C04B 41/5353; C04B 2235/60
USPC 156/345.23

(57) ABSTRACT

A fixture for etching PCD drill inserts is provided. The fixture system includes an etching fixture having a body with a generally cylindrical top section, a bore through the body allowing a cylindrical cutting insert to be placed into the body and to extend partially out of the bore, and a sealing element disposed adjacent an end of the bore to seal against a cutting insert which is inserted into the bore. The fixture system also includes a cap disposed over the top section of the body which extends around the outside of the top section of the etching fixture body and engages the outside of the top section of the body to seal against the body and seal the first end of the bore.

### THE FIELD OF THE INVENTION

The present invention relates to acid etching of polycrystalline diamond compact cutting inserts. More specifically, the present invention relates to a support fixture and sealing cap for the acid etching of polycrystalline diamond (PCD) inserts used in drill bits and industrial cutters.

### BACKGROUND

PCD inserts are used to form the cutting tips on underground drill bits, such as those used to drill oil and gas wells. Such inserts are cylindrical in nature, having a substrate which is typically sintered carbide and a layer of sintered polycrystalline diamond on an end of the cylinder. Multiple of such inserts are attached to drill bits as the PCD forms a durable cutting edge.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 shows an etching system.

FIG. 2 shows a perspective view of a PCD drilling insert.

FIG. 3 shows a perspective view of an etching fixture.

FIG. 4 shows cross-sectional view of the etching fixture.

FIG. 5 shows a detailed view of a section of the etching fixture.

FIG. 6 shows another detailed view of a section of the etching fixture.

FIG. 7 shows a side view of the etching fixture.

FIG. 8 shows a bottom view of the etching fixture.

FIG. 9 shows a perspective view of a cap.

FIG. 10 shows a bottom view of the cap.

FIG. 11 shows a side view of the cap.

FIG. 12 shows a top view of the cap.

FIG. 13 shows a cross-sectional view of the cap.

It will be appreciated that the drawings are illustrative and not limiting of the scope of the invention which is defined by the appended claims. The embodiments shown accomplish various aspects and objects of the invention. It is appreciated that it is not possible to clearly show each element and aspect of the invention in a single figure, and as such, multiple figures are presented to separately illustrate the various details of the invention in greater clarity. Similarly, not every embodiment need accomplish all advantages of the present invention.

### DETAILED DESCRIPTION

In the following description, numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

Reference throughout this specification to “one embodiment”, “an embodiment”, “one example” or “an example” means that a particular feature, structure or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

While PCD cutting inserts provide a durable cutting edge, the solvent metal which occupies the interstitial spaces between the diamond crystals can cause degradation of the insert during use. In the sintered diamond layer, the diamond often accounts for about 85 to 95 percent of the PCD, and the remaining material is a metal which acts as a solvent for carbon and a catalyst for diamond formation while sintering the PCD. The fraction of solvent metal is sufficient to cause problems while using the PCD cutting insert. One problem is that the solvent metal expands more with temperature than diamond, and can cause cracking of the PCD layer as the cutting insert is used. Another limitation is that the solvent metal, being a solvent for carbon during the formation of diamond crystals, also acts as a carbon solvent for the degradation of the diamond at elevated temperatures. As such, the solvent metal remaining in the PCD causes the diamond to convert into carbon dioxide, carbon monoxide, or graphite at temperatures near 700 degrees Celsius. As such, it is desirable to remove the solvent metal from the PCD cutting inserts before use. The solvent metal may be etched from the PCD using a mixture of strong acids, such as hydrofluoric and nitric acids (HF and HNO₃).

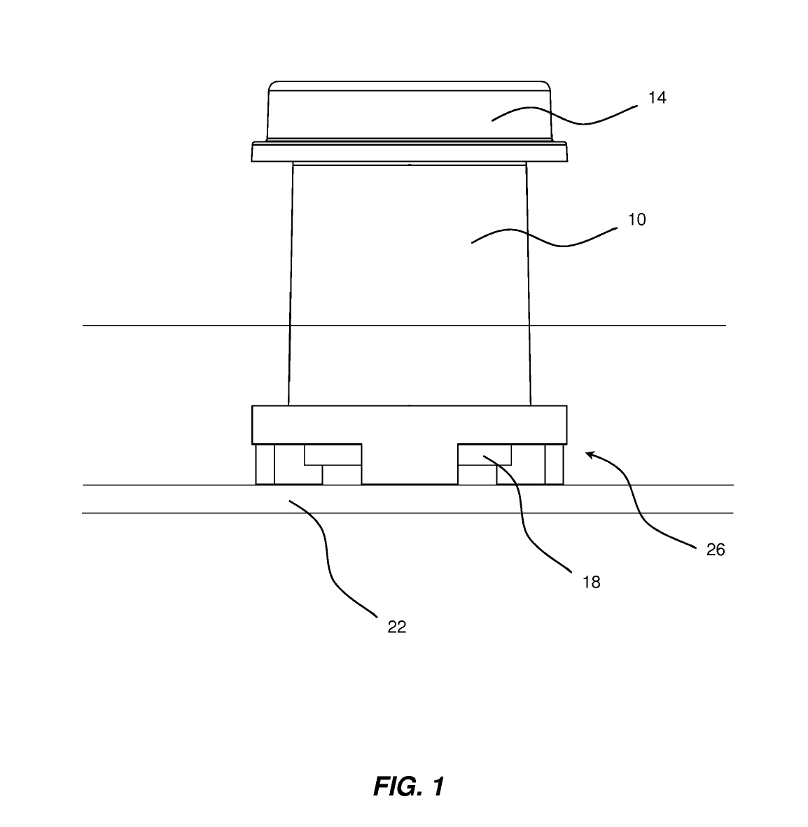

Referring to FIG. 1, an example system for etching PCD cutting inserts is shown. The system may include an etching fixture 10 and a cap or lid 14 which are used to etch a PCD insert 18. The PCD insert 18 is typically cylindrical and includes a sintered carbide body with a layer of sintered diamond on an end of the carbide body. The PCD insert 18 is inserted into the fixture 10 so that a portion of the diamond layer protrudes from the bottom of the fixture and the end of the PCD insert can be etched. A cap 14 is placed on the fixture 10 and the fixture 10 is placed into an etching tray 22. The fixture 10 typically holds the bottom of the PCD insert 18 off of the surface of the etching tray 22 to facilitate etching the PCD insert. Typically, the tray 22 holds a number of fixtures for etching.

Concentrated acid 26 is placed into the etching tray 22 so that the acid 26 covers the bottom of the fixture 10 and the exposed bottom end of the PCD insert 18. The acid 26 is kept at a desired temperature for a desired time period to etch metal from the sintered diamond PCD insert 18. The inserts 18 may often be etched for a long period of time, and may sometimes be etched for a period of 5 to 10 days in order to remove the solvent metal from the sintered diamond to a desired depth.

In removing the solvent metal from the sintered diamond with acid, it is typically necessary to protect the insert substrate from the acid, as it is not desirable to etch or erode the substrate. The fixture 10 provides a sharp delineation between etched and non-etched diamond, allowing the diamond to be etched more consistently and allowing the diamond layer to be etched to a level closer to the substrate. It is also necessary to protect the substrate of the PCD insert from acid vapors while etching the diamond layer. Since the acid 26 is strong, corrosive acid vapors are typically present in the etching tray.

The cap 14 is installed on the top of the fixture 10 and seals against the top of the fixture 10 to prevent liquid and vapors from entering the interior of the fixture and etching the insert 18. The cap 14 creates a slight positive pressure within the fixture 10 when installed on the fixture. The positive pressure helps keep the acid from leaking into the fixture and provides an additional measure of safety in etching the PCD inserts.

The fixture 10 and the cap 14 may be injection molded, significantly reducing the cost of the fixture and cap. The fixture 10 is typically a thermoplastic polymer and the cap 14 is typically a thermoplastic elastomer. By reducing the cost of the fixture, the fixture may simply be discarded after use rather than cleaning the fixture for reuse.

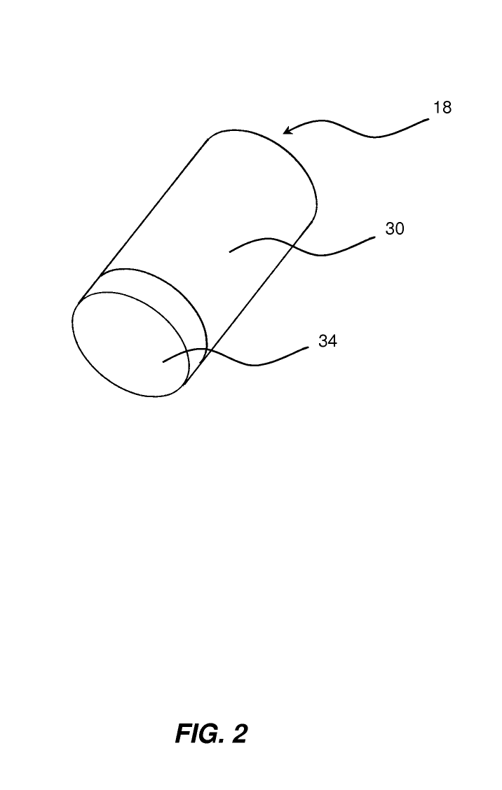

FIG. 2 shows a typical PCD cutter insert 18. The insert 18 includes a substrate 30 and a PCD layer 34. As discussed, the substrate 30 is typically sintered carbide, which is a sintered mixture of metal carbides and metals. The PCD layer 34 is typically sintered diamond and may include about 85 to 95 percent diamond crystals and the remainder an appropriate solvent catalyst metal which is active in sintering diamond at high temperature and pressure. The insert 18 is typically a cylindrical shape, and includes a circular cross section and flat ends. The PCD layer 34 is typically a round disk shape and is bonded to an end of the substrate 30.

The insert 18 is typically about 0.5 inches in diameter and about 0.75 inches in length. The substrate 30 may be about 0.5 inches in diameter and about 0.6 inches in length. The PCD layer 34 may be about 0.5 inches in diameter and between about 0.1 and 0.2 inches in length. The insert 18 may be made in somewhat larger or smaller sizes to fit different sizes of cutting drills. The insert 18 is often manufactured by sintering the carbide and metal substrate 30 and the diamond and metal PCD layer 34 at high temperature and pressure to create a sintered structure having the layers and construction shown. The insert 18 is typically then ground to final dimensions.

PCD inserts 18 may commonly be 13, 16 or 19 millimeters in diameter. This application primarily discusses the 13 mm diameter insert as an example. Other sizes of inserts 18 would use a correspondingly sized fixture 10, with similar clearance or interference in the fit. The 13 millimeter insert may be casually referred to herein as a one half inch insert, since 13 mm is 0.512 inches in diameter.

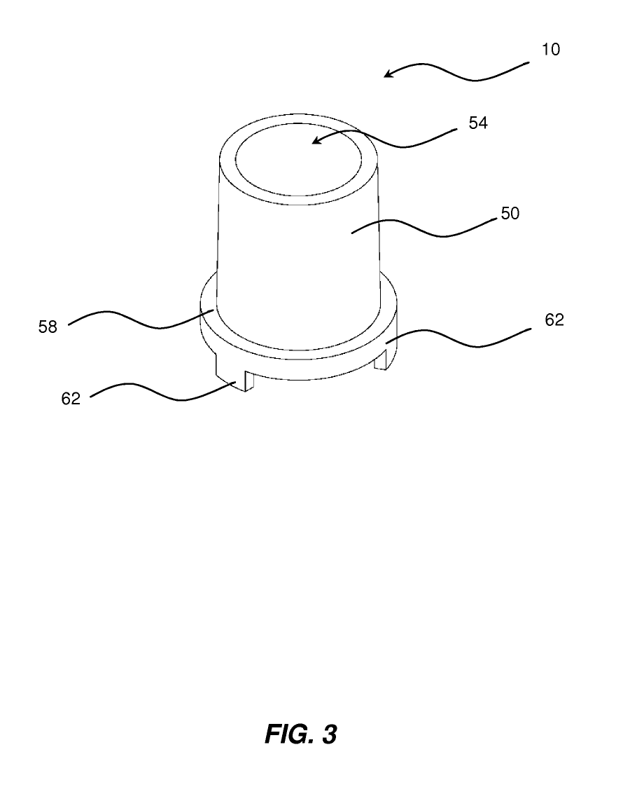

Turning now to FIG. 3, a perspective view of the fixture 10 is shown. The fixture 10 has a body 50 which is generally cylindrical, and has a bore 54 therethrough and a base 58 formed at the bottom thereof. The bore 54 is sized to receive a PCD insert 18. As there are different diameters of PCD inserts, different diameters/sizes of fixtures 10 are made. The base 58 may extend radially outwardly from the bottom of the body 50. A plurality of feet 62 extend downwardly from the base 58. The feet 62 elevate the base 58 and the diamond face of the insert 18 which is being etched to raise these off of the bottom of the etching tray 22 and allow for better circulation of the acid 26 around the PCD insert 18. Using a structure such as feet 62 to elevate the PCD insert 18 off of the tray 22 improves the etching of the insert.

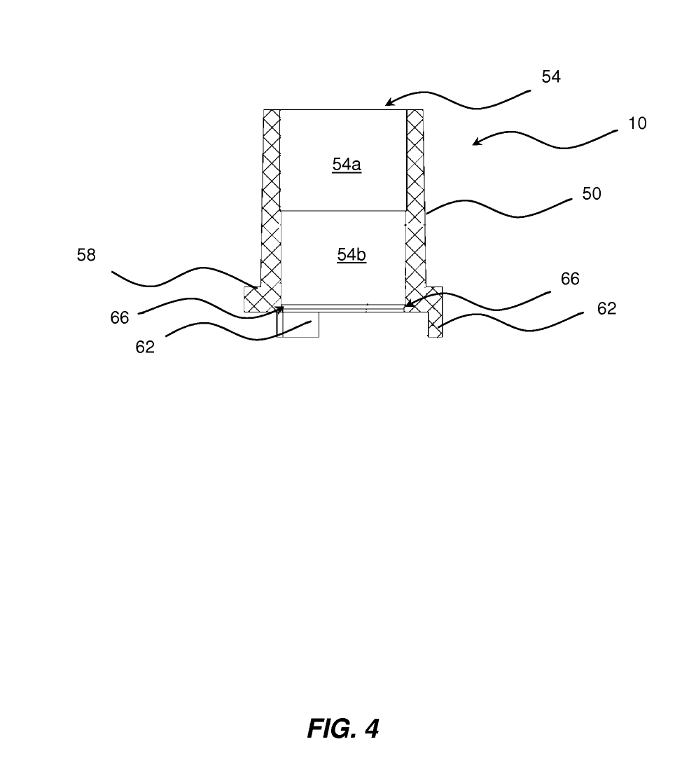

FIG. 4 shows a cross-sectional view of the fixture body 50. As shown, the bore 54 may be made with two sections of different diameter. As shown, the top portion 54a of the bore (approximately the top half) is a few hundredths of an inch larger in diameter than an insert 18, and for this example, may have an inside diameter of about 0.533 inches. The top portion 54a may be between 1 and 4 hundredths of an inch larger in diameter than the insert 18. The lower portion 54b of the bore (approximately the lower half) may be smaller in diameter than the top portion 54a and larger in diameter than the insert 18. The lower portion 54b may be between about 5 thousandths of an inch and a few hundredths of an inch larger in diameter than the insert 18, and may be about one hundredth of an inch larger in diameter than the insert 18. For this example, the lower portion 54b of the bore 54 may have a diameter of about 0.525 inches. Having a bore 54 with these relative diameters allows an insert 18 to easily be placed within the fixture body 50 while keeping the insert aligned within the body.

A small rib 66 is formed at the bottom of the bore 54. The rib 66 seals against an insert 18 which is pressed through the top of the bore 54, through the lower end of the bore 54 and past the rib 66 by a desired amount.

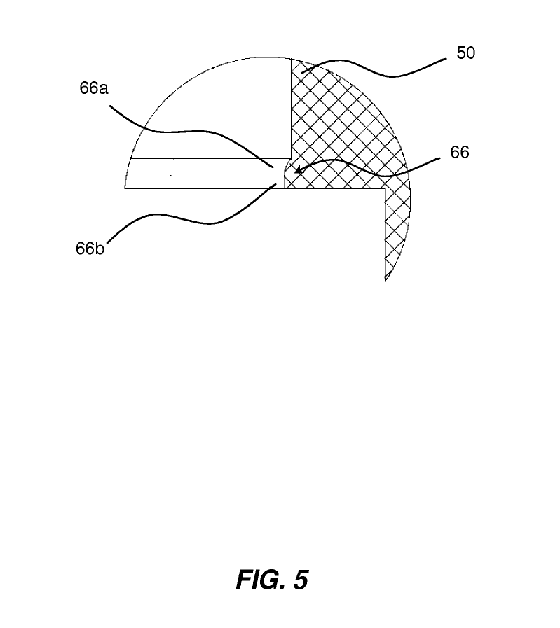

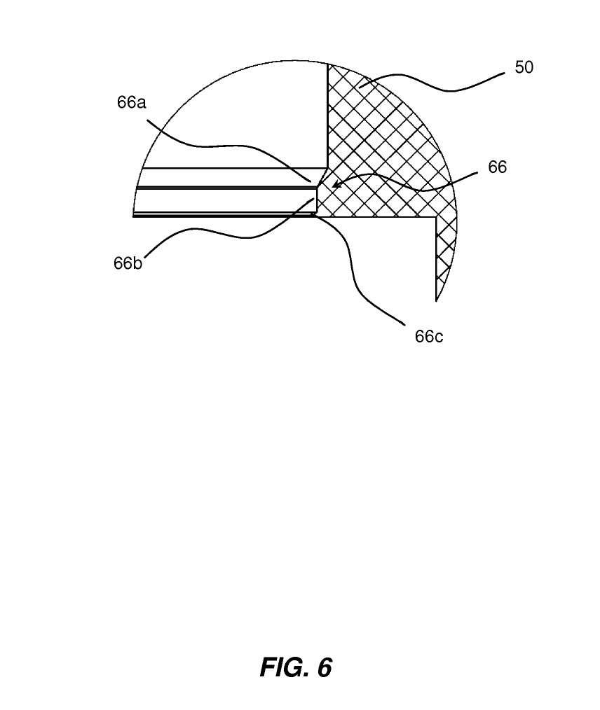

FIG. 5 and FIG. 6 show detailed views of the rib 66. The rib 66 extends approximately 0.03 inches into the bore 54, making the diameter of the bore 54 at the rib 66 approximately 0.495 inches. The rib thus forms an interference fit with a 0.512 inch diameter PCD drill insert. It is currently preferred to have a rib 66 which is between about 0.01 inches and 0.04 inches smaller in diameter than the insert 18, and which may be about 0.02 inches smaller than the insert 18. In loading the fixture 10, an insert 18 is placed into the bore 54 with the diamond layer 34 facing down and the insert 18 is pressed through the rib 66 so that the insert 18 extends past the rib 66. When an insert 18 is pressed into the body 50, the rib 66 seals against the insert. As shown in FIG. 5, the rib 66 may have a radiused upper portion 66a which transitions into a lower sealing portion 66b. The upper portion of the rib 66 may taper and may gradually transition between the bore 54 and the sealing portion of the rib. The upper portion and lower portion may both be between about 0.01 and 0.03 inches in height, and have a protrusion into the bore 54 as discussed.

As shown in additional detail in FIG. 6, the rib 66 may have an upper portion 66a which transitions from the bore 54 to a lower sealing portion 66b. The sealing portion 66b protrudes into the bore 54 as discussed above to create an interference fit between about 0.01 and 0.03 inches with the insert. The upper transition portion 66a and the lower sealing portion 66b may both between about 0.01 and 0.03 inches in height. The rib 66 may also have a smaller secondary rib 66c extending outwardly (i.e. inwardly) from the lower portion 66b and further into the bore 54. The secondary rib 66c may typically between about 0.001 and 0.01 inches in both height and width (protrusion into the bore 54), and preferably may be about 0.003 inches in height and protrusion into the bore.

The upper transition region 66a helps the insert move smoothly past the rib 66 without causing damage. The lower sealing region 66b presses against the insert 18 to seal against the insert. The secondary rib 66c, if used, provides a more easily deformable section of material to the sealing rib 66 and can improve the effectiveness and reliability of the sealing rib 66.

Different etching conditions such as time or temperature may affect the inner size of the rib 66, requiring the rib to be larger or smaller in size. Thus, the interior diameter defined by the rib 66 may be a few hundredths of an inch larger or smaller. Typically, a similar amount of interference is used between the rib 66 and different sizes of inserts 18, such as a 16 or 19 millimeter insert. That is to say that the difference in size between the inner diameter of the rib 66 and the outer diameter of the insert 18 may be approximately the same. Advantageously, the fixture 10 may be adapted to receive 16 or 19 millimeter diameter inserts by changing the diameter of the body 50 while leaving the diameter of the base 58 and location of the feet 62 the same. This allows the use of the same loading and processing equipment for different insert sizes.

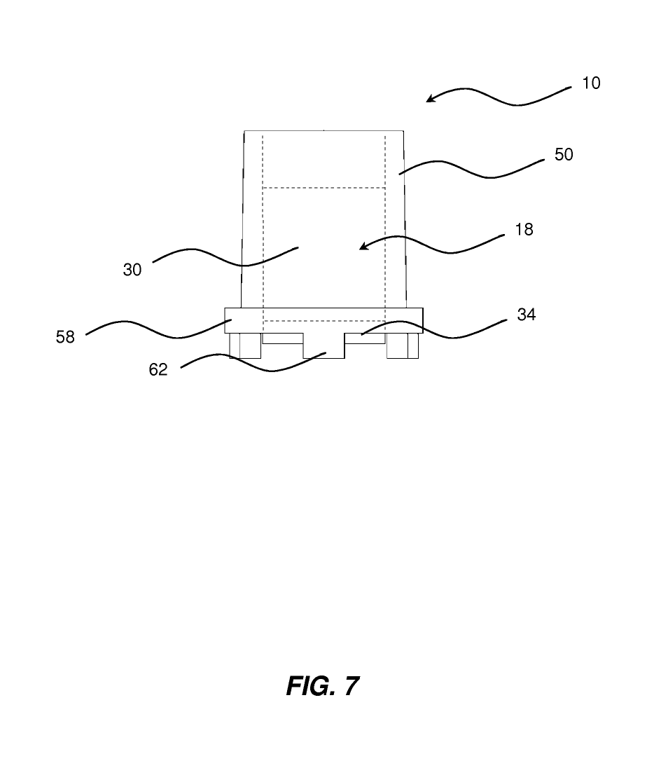

FIG. 7 shows a side view of the fixture body 50 with an insert 18 loaded therein. The insert 18 is placed into the top of the bore 54 and pressed downwardly past the rib 66. A simple pressing jig can be made which contacts the bottom of the base 58 and which allows the insert 18 to move downwardly past the base 58 a predetermined distance before stopping the insert. This allows the insert 18 to be easily and repeatably loaded into the fixture body 50. The fixture 10 achieves a significant time savings in loading the insert 18 as well as providing a much more accurate and repeatable loading and etching process. The improved accuracy and repeatability of loading and etching allows the diamond layer 34 to be etched closer to the substrate 30. This improves the performance of the etched insert 18.

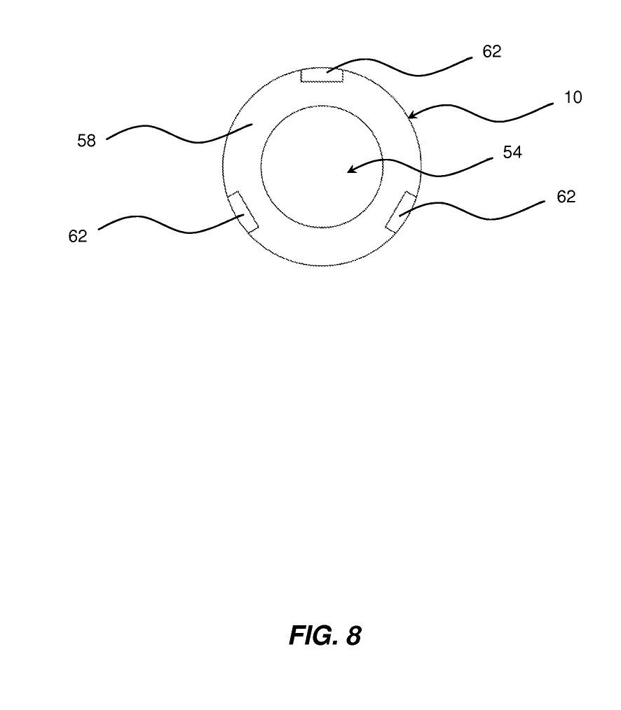

FIG. 8 shows a bottom view of the fixture body 50, showing the placement of the feet 62. FIGS. 7 and 8 illustrate how the fixture body 50 keeps the diamond layer 18 off of the bottom of the etching tray 22, and allows better circulation of acid around the etched face of the diamond layer 18. This allows for more consistent etching of the diamond layer 18.

The fixture 10 may be formed from a plastic such as polypropylene, polyethylene, polyvinylidene fluoride, polytetraflouroethylene, and mixtures thereof. Other suitable plastics are Liquid Crystal Polymer (LCP) or PolyEtherKetone (PEK). A suitable material is C3350 TR polypropylene co-polymer.

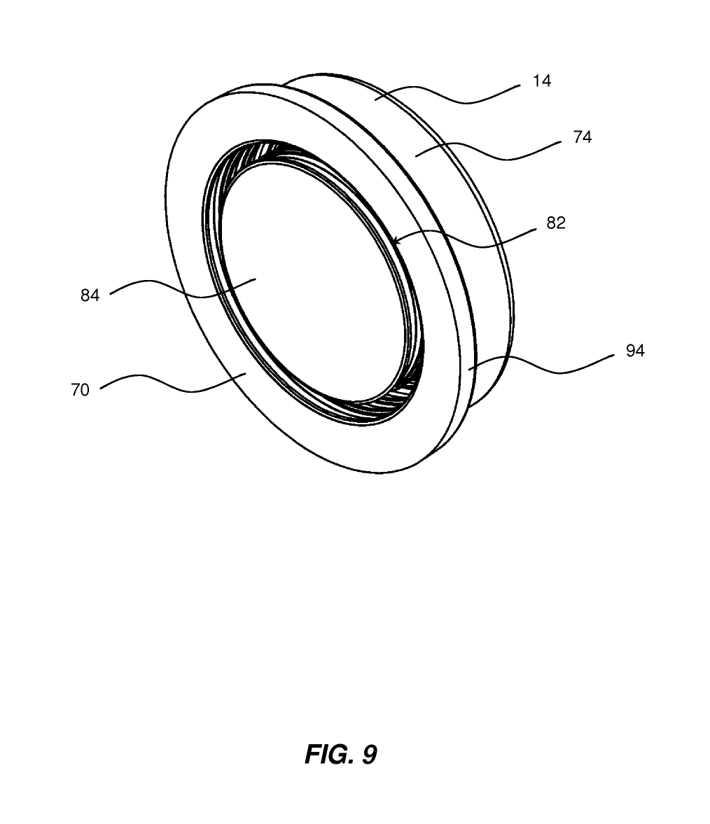

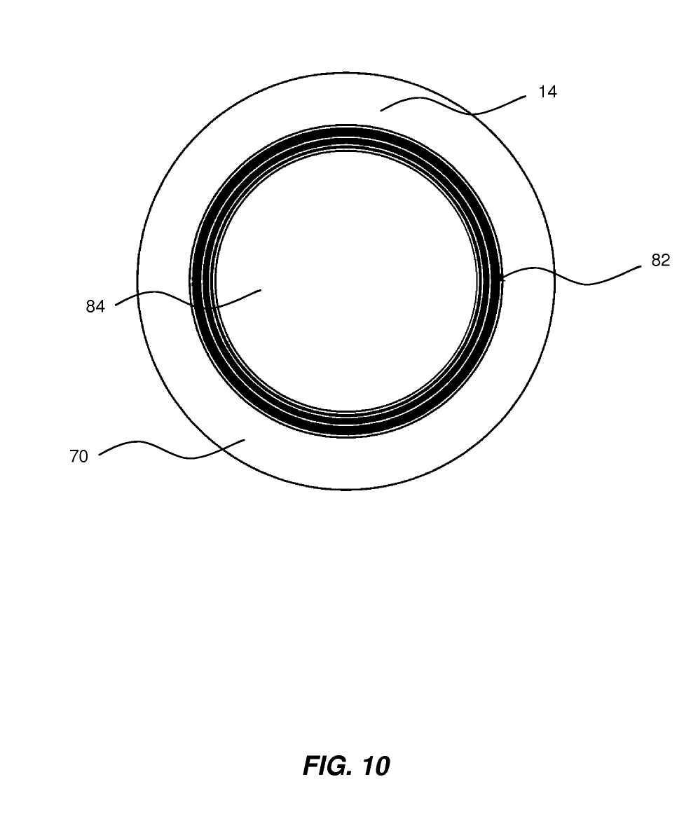

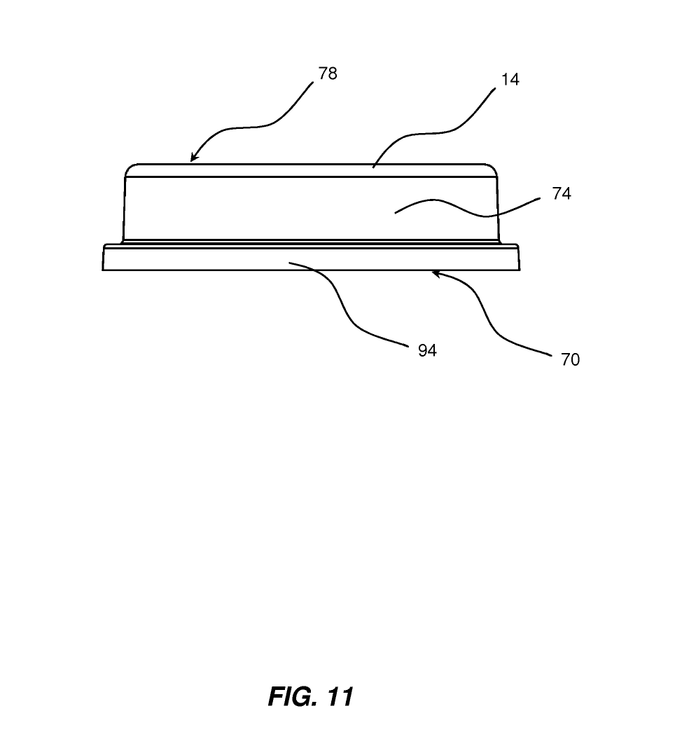

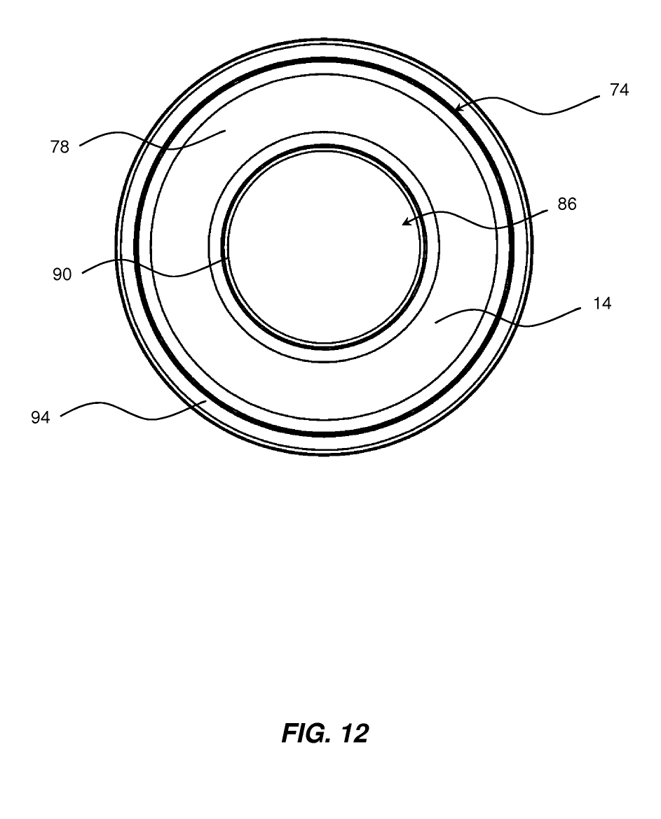

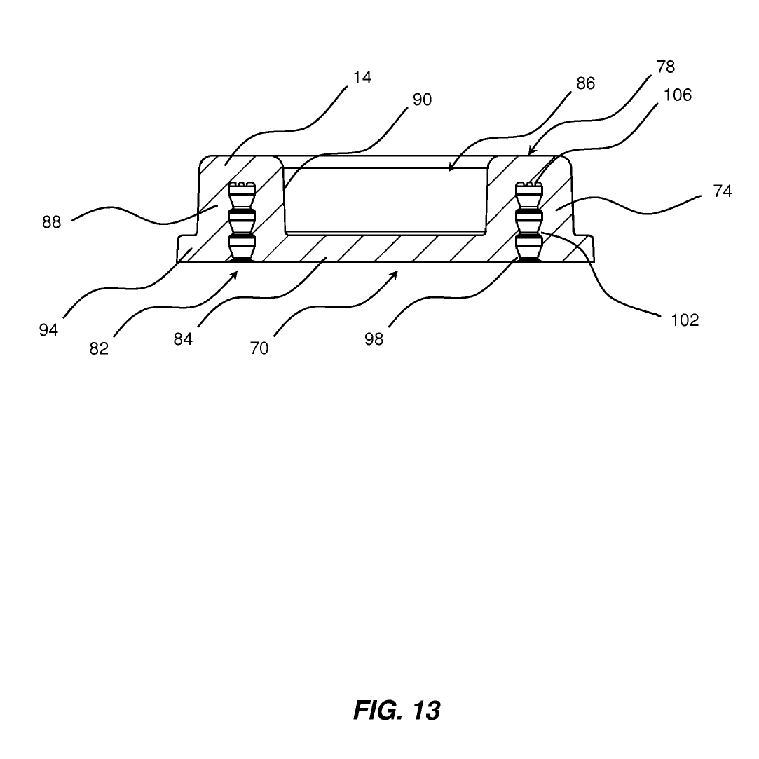

FIGS. 9 through 13 show the cap 14. FIG. 9 shows a perspective view of the cap 14. FIG. 10 shows a bottom view of the cap 14. FIG. 11 shows a side view of the cap 14. FIG. 12 shows a top view of the cap 14. FIG. 13 shows a cross-sectional view of the cap 14. The cap 14 is used to seal the top of the fixture 10 and to protect certain parts of the insert 18 such as the insert substrate 30 during the etching process. As discussed, it is typically not desirable to etch the substrate 30. During the etching process, the concentrated acid 26 forms acid vapors. The etching tray 22 is typically used with a lid to contain the acid 26 and protect the acid bath from contaminants. As a result, a corrosive environment of acid vapors exists in the etching tray 22 around the fixtures 10. The cap 14 particularly keeps acid vapors out of the etching fixture 10 during extended etching processes.

The top of the fixture 10 may form a circular wall defined by a smooth round (cylindrical) outer surface, a flat upper surface, and the round interior bore 54. An example fixture 10 may have a round upper wall which is about 0.05 inches (1.25 mm) thick. The cap 14 is designed to fit over the top of the fixture 10, and may engage the bore 54, the outer surface of the body 50, and the top of the fixture body 50. The cap 14 may be formed from a thermo plastic elastomer.

The cap 14 has a lower surface 70, a generally cylindrical sidewall 74, and an upper surface 78. A groove 82 is formed in the lower surface 70. The groove 82 extends upwardly into the lower surface 70 of the cap. The edges of the groove may define a cylindrical center plug 84 and an outer circumferential band 88. The groove 82 fits over the upper wall of the fixture 10 and the cylindrical plug 84 engages the bore 54 while the outer circumferential band 88 engages the outside of the body 50. The groove 82 may also engage the top of the insert 10. The upper surface 78 of the cap 14 may include a recessed center portion 86 located inside of the cylindrical plug 84. The recessed center portion 86 of the top 78 of the cap 14 may allow a relatively uniform thickness of material to be formed above and to the sides of the groove 82, as is visible in FIG. 13. Thus, the bottom 70, outer side wall 74, top 78, and inner side wall 90 may all be approximately the same thickness. An example cap 14 may be about 0.05 inches thick around the groove (i.e. the bottom 70, outer side wall 74, top 78, and inner side wall 90). The cap 14 may include a shoulder ridge 94 which extends laterally out from the outer side wall 74. The lateral shoulder ridge 94 may increase the sealing pressure of the cap 14 against the outside of the fixture 10.

The groove 82 may be formed with internal sealing ridges which assist in sealing between the cap 14 and the fixture 10. These ridges are particularly visible in FIG. 13. A first set of ridges 98 may be formed on inside side wall of the groove 82. The cap 14 may include 3 inside sealing ridges 98. These inside ridges 98 may be angled downwardly such that the lower flank of the ridge is more steeply inclined (more perpendicular to the groove 82) and the upper flank of the ridge is less steeply inclined than the lower flank of the groove. Additionally, a relatively flat section which is generally parallel to the groove 82 may separate adjacent ridges 98.

A second set of ridges 102 may be formed on the outside wall of the groove 82. The cap 14 may include 3 outside ridges. The outside sealing ridges 102 may also be angled downwardly and be formed with a lower flank which is more steeply inclined (more perpendicular to the groove 82) and an upper flank which is less steeply inclined than the lower flank of the groove. The outside ridges 102 may also be formed with a relatively flat section between adjacent ridges. The lower flanks of the inside ridges 98 and the outside ridges 102 may be formed at approximately a 60 degree angle relative to the side of groove 82. The upper flanks of the inside ridges 98 and the outside ridges 102 may be formed at approximately a 30 degree angle relative to the side of the groove 82. A third set of ridges 106 may be formed on the top of the groove 82. The cap 14 may include two of these upper sealing ridges 106.

An example cap may provide a groove 82 which is about 0.05 inches wide and about 0.2 inches tall. The inner ridges 98 and outer ridges 102 may be about 0.015 inches tall and about 0.03 inches wide at the base. A flat area about 0.02 inches wide may be located between the ridges 98, 102. The upper ridges 106 may be about 0.01 inches tall. The upper ridges may be about 0.01 inches wide at the base and have a space of about 0.01 inches between the upper ridges 106.

In one example, a fixture 10 for a nominal 16 mm insert 18 may have an bore 54 with a top portion 54a which is 0.628 inches in diameter (15.95 mm) and a bottom portion 54b which is 0.618 inches in diameter (15.7 mm). The outer diameter of the top of the body 50 may be 0.728 inches in diameter (18.49 mm). The cap 14 may have inner ridges 98 with an outer diameter of 0.632 inches (16.05 mm) and outer ridges 102 which are 0.722 inches (18.35 mm) in diameter. The inner ridges 98 may be about 0.004 inches (0.1 mm) larger in diameter than the top portion 54a of the bore 54. The outer ridges 102 may be about 0.006 inches (0.15 mm) smaller in diameter than the outside of the top of the body 50. The inner ridges 98 may be between 0.002 inches (0.05 mm) and 0.01 inches (0.25 mm) larger in diameter than the top portion 54a of the bore 54. The outer ridges 102 may be between 0.002 inches (0.05 mm) and 0.015 inches (0.6 mm) smaller in diameter than the outside of the top part of the body 50.

FIG. 14 shows a cross-sectional view of the fixture 10 and cap 14 ready for etching an insert 18. The fixture 10 has a PCD insert 18 which has been loaded into the body 50 by pressing the insert 18 down through the rib 66 to expose a desired length of the sintered diamond layer 34. After pressing the insert 18 into place, a cap 14 is pressed onto the top of the body 50. The cap 14 extends downwardly into the bore approximately 0.2 inches. The cap 14 has a slight interference fit with the bore 54 and the outside of the body 50, sealing against the bore 54 and body 50 as it is pushed into place. As such, inserting the cap compresses the air in the bore 54 and the air in the groove 82 and causes a positive pressure to be formed inside of the bore 54 and groove 82. This positive pressure helps to keep the etching acid and acid vapors out of the bore 54 while etching the insert 18, further reducing the risk of leakage.

The shoulder ridge 94 of the cap 14 extends outwardly beyond the body 50 of the fixture 10 and forms a lifting flange which makes it easier to move the fixtures 10 into and out of the etching tray 22.

One significant advantage of the fixture 10 is that the boundary between etched and non-etched portions of the diamond layer 18 can be precisely controlled. The rib 66 forms a sharp delineation between etched and non-etched diamond compact. The precise control of the etching boundary allows the insert 18 to be mounted into the fixture 10 with a greater amount of the diamond layer 18 exposed, improving the temperature stability and useful life of the etched insert.

Another significant advantage of the fixture 10 is the reduction of leaks during etching. Prior art etching devices have had a failure rate of between 2 and 5 percent. The present fixture 10 has experienced a failure rate of less than one percent. The reduction of the failure rate is significant because of the cost associated with producing the inserts 10 and the time and cost of etching the inserts. The thermoplastic elastomer cap 14 has provided a significant benefit in the etching process as it provides a reliable seal against acid and acid vapors and protects the insert substrate 30 from damage during the etching process.

There is thus disclosed an improved etching fixture for PCD drill inserts. The above description of illustrated examples of the present invention, including what is described in the Abstract, are not intended to be exhaustive or to be limitation to the precise forms disclosed. While specific embodiments of, and examples for, the invention are described herein for illustrative purposes, various changes may be made to the present invention without departing from the scope of the claims.

What is claimed is:

1. A fixture system for etching cylindrical PCD inserts, the PCD inserts having a generally cylindrical substrate and a layer of sintered polycrystalline diamond attached to an end of the substrate, the fixture system comprising:
an etching fixture having a body with;
a bore therethrough allowing a cylindrical PCD insert to be placed into the body and to extend partially out of the bore;
a sealing element adjacent the bottom of the bore, the sealing element extending inwardly into the bore to seal against a PCD insert; and
a cap disposed on a top of the body, wherein the cap extends over an outside of the etching fixture body and engages the outside of the body to seal against the body and thereby seal a top of the bore.

2. The fixture system of claim 1, wherein the cap has a groove formed in the bottom thereof, and wherein the groove engages the outside of the body and the inside of the bore to thereby seal against the body.

3. The fixture system of claim 2, wherein the cap comprises:
an inside sealing ridge formed on an inside wall of the groove, wherein the inside sealing ridge engages the bore of the fixture; and
an outside sealing ridge formed on an outside wall of the groove, wherein the outside sealing ridge engages the outside of the fixture body.

4. The fixture system of claim 3, wherein the cap comprises an upper sealing ridge formed on a top of the groove, wherein the upper sealing ridge engages a top of the fixture body.

5. The fixture system of claim 3, wherein the inside sealing ridge and the outside sealing ridge have a lower flank disposed at an angle of about 60 degrees to the groove and an upper flank disposed at an angle of about 30 degrees to the groove.

6. The fixture system of claim 3, wherein the cap comprises multiple inside sealing ridges and multiple outside sealing ridges.

7. The fixture system of claim 3, wherein the inside sealing ridge is between about 0.002 and 0.01 inches larger in diameter than an inside of the bore, and wherein the outside sealing ridge is between about 0.002 and 0.015 inches smaller in diameter than the outside of the fixture body.

8. The fixture system of claim 2, wherein a top of the cap comprises a recessed center portion extending downwardly inside of the groove.

9. The fixture system of claim 1, wherein the cap is formed of a thermoplastic elastomer.

10. The fixture system of claim 1, wherein the cap forms an interference fit while sliding into the bore so as to raise the air pressure inside of the bore when an insert is loaded into the bore and the cap is then inserted onto the fixture.

11. The fixture system of claim 1, further comprising a generally cylindrical PCD insert disposed in the bore, the insert comprising a generally cylindrical substrate and a layer of sintered polycrystalline diamond disposed on an end thereof.

12. The fixture system of claim 11, wherein the etching fixture is placed in acid to etch the insert.

13. A fixture system for etching cylindrical cutting inserts, the fixture system comprising:
an etching fixture having:
a body having a generally cylindrical top section;
a bore through the body, the bore having a first end disposed adjacent the top section of the body and a second end, the bore allowing a cylindrical cutting insert to be placed into the body and to extend partially out of the second end of the bore;
a sealing element disposed adjacent the second end of the bore, the sealing element extending inwardly into the bore to seal against a cutting insert which is inserted into the bore; and
a cap disposed over the top section of the body, wherein the cap extends around the outside cylindrical top section of the etching fixture body and engages the outside of the top section of the body to seal against the body and thereby seal the first end of the bore.

14. The fixture system of claim 13, wherein a bottom of the cap has a circular groove formed therein, and wherein the top section of the body is received into the groove.

15. The fixture system of claim 14, wherein the cap has an outer portion which engages the outside of the top section of the body and an inner plug which engages the bore.

16. The fixture system of claim 14, wherein the cap comprises an inside sealing ridge formed on an inside side of the groove which engages the bore and an outside sealing ridge formed on an outside side of the groove which engages the outside of the top section of the body.

17. The fixture system of claim 16, wherein the inside sealing ridge is between about 0.002 and 0.01 inches larger in diameter than an inside of the bore, and wherein the outside sealing ridge is between about 0.002 and 0.015 inches smaller in diameter than the outside of the top section of the fixture body.

18. The fixture system of claim 16, wherein the cap comprises a sealing ridge formed on a top of the groove.

19. The fixture system of claim 15, wherein the cap forms an interference fit while sliding into the bore so as to raise the air pressure inside of the bore when an insert is loaded into the bore and the cap is then inserted onto the fixture.
